(19) United States
(12) Patent Application Publication
(10) Pub. No.: US 2006/0215980 A1
(43) Pub. Date: Sep. 28, 2006

(54) Splice tray arrangement

(76) Inventors: Yilmaz Bayazit, Minneapolis, MN (US); Scott C. Kowalczyk, Savage, MN (US); Chad J. Sjodin, Shakopee, MN (US)

Correspondence Address: MERCHANT & GOULD PC, P.O. BOX 2903, MINNEAPOLIS, MN, 55402-0903, US

(21) Appl. No.: 11/089,437

(22) Filed: Mar. 24, 2005

(51) Int. Cl. G02B 6/00

(52) U.S. Cl. 385/135

(57) ABSTRACT

A splice tray having an arrangement for holding splice components, and an arrangement for storing cable slack. Each of the arrangements being integrally formed or integrally molded with the base of the splice tray to form a one-piece unit. The arrangement for holding splice components including diagonally oriented splice holding channels having curved entrance regions and curved exit regions. The arrangement for storing cable slack including first and second radius limiters. The arrangements being constructed and arranged relative to one another such that no portion of a cable placed within the splice tray exceeds a minimum bend radius.

### TECHNICAL FIELD

This disclosure relates generally to devices used in the telecommunications industry. More particularly, this disclosure relates to a splice tray used for managing and storing fiber optic cables.

### BACKGROUND

A wide variety of telecommunication applications utilize fiber optic cables, and in turn involve fiber optic cable splicing and fiber optic cable storage. In these applications, care must be taken to avoid unnecessary or excessive bending of the cables. Bending of fiber optic cables can, for example, cause attenuation and loss of signal strength. As the cable's fiber bends, the fiber can also break, resulting in complete loss of signal transmission through the fiber. In general, improvements to conventional arrangements for managing spliced fiber optic cables and for storing fiber optic cables are desired.

### SUMMARY

One aspect of the present invention relates to a splice tray arrangement having a base, first and second radius limiters, and a splice holding element. The first and second radius limiters are integrally formed on the base, and the splice holding element is integrally molded on the base. The holding element includes retaining structure configured to receive a plurality of splice components. The retaining structure is oriented at a non-perpendicular angle relative to longitudinal and transverse dimensions of the base.

Another aspect of the present invention relates to a splice tray arrangement having a base, first and second radius limiters, and splice holding channels. The splice holding channels are positioned between the first and second radius limiters, and each include a curved entrance region and a curved exit region.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is an exploded perspective view of a splice tray arrangement according to the principles of the present disclosure;

FIG. 2 is a top plan view of a splice tray of the splice tray arrangement of FIG. 1;

FIG. 3 is an enlarged, cross-sectional view of a portion of the splice tray of FIG. 2, taken along line 3-3; and

FIG. 4 is an enlarged, cross-sectional view of another portion of the splice tray of FIG. 2, taken along line 4-4.

### DETAILED DESCRIPTION

Reference will now be made in detail to various features of the present disclosure that are illustrated in the accompanying drawings. Wherever possible, the same reference numbers will be used throughout the drawings to refer to the same or like parts.

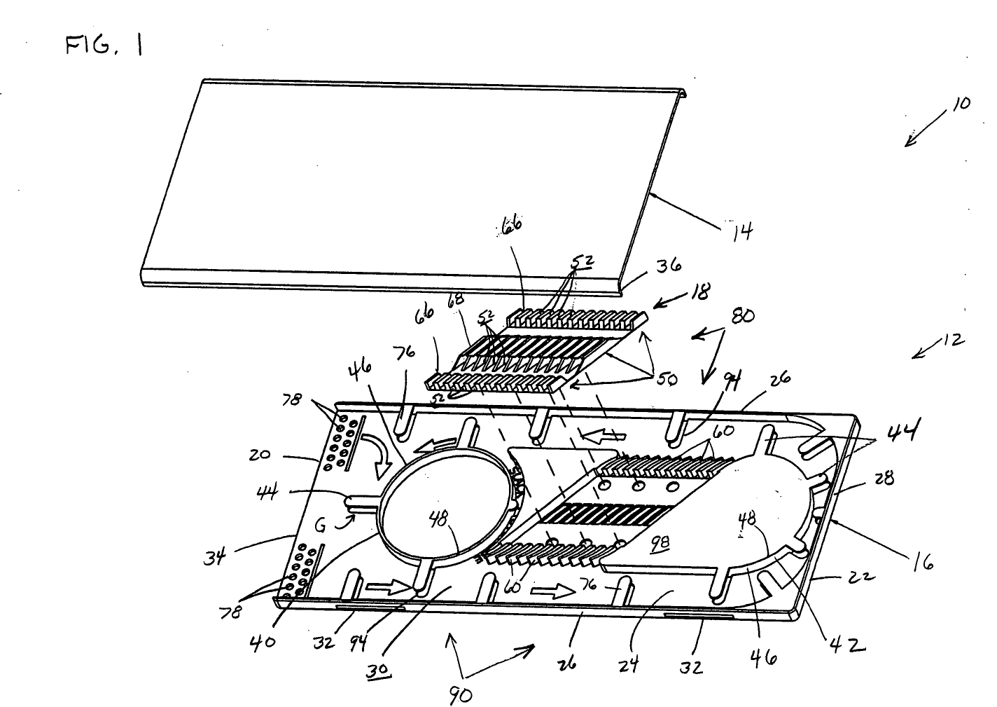

FIGS. 1-4 illustrate a splice tray arrangement 10 having features that are examples of how inventive aspects in accordance with the principles of the present disclosure may be practiced. Preferred features are adapted for promoting cable management and preventing cable attenuation due to excessive cable bending.

The splice tray arrangement 10 of the present disclosure is used to house spliced fiber optic cables 100 (FIG. 2). In splicing fiber optic cables, two fiber optic cables are joined or spliced together by a splice component 110 (FIG. 2). The splice component can include a mass fusion splice component 114, used to join ribbon cables; or a stranded heat shrink splice component 112, used to join single-fiber cables, for example. The splice tray arrangement 10 of the present disclosure includes an arrangement 80 for holding or retaining the splice components 110 (e.g. 112, 114). In use, a generous portion of slack cable is often provided to permit maintenance or replacement of the splice components 110 without requiring cable replacement. To accommodate the slack cable, the splice tray arrangement 10 of the present disclosure also includes an arrangement 90 for storing slack cable.

Referring to FIG. 1, embodiments of a splice tray 12 and a cover 14 of the splice tray arrangement 10 are illustrated. The splice tray 12 of the tray arrangement 10 generally includes a base 16 and a splice holding element 18. The base 16 of the splice tray 12 is preferably a molded construction. The base 16 can be molded from common engineering materials including common engineering polymers such as polybutylene terephthalate (PBT), polycarbonate (PC), polyethylene ether (PPE), and polystyrene (PS), for example. The cover 14 can be molded or manufactured from similar or different materials than that of the base 16.

During manufacture of the splice tray 12, the holding element 18 is over-molded to the base 16 so that the holding element 18 and the base 16 are integral. That is, the holding element 18 is not attachable or detachable from the base 16; rather, the splice tray 12 is constructed such that the base 16 and the holding element 18 are a one-piece unit.

Referring still to FIG. 1, the base 16 of the splice tray 12 includes a generally planar surface 24 (FIG. 1) having a first end 20 and a second end 22. Tray sides extend outward from the planar surface 24. In the illustrated embodiment, the tray sides include two opposing sides 26 and a side 28 transverse to the two opposing sides 26. The transverse side 28 is located at the second end 22 of the base 16. The base 16 has a generally longitudinal dimension L extending between the first end 20 and the second end 22, and a transverse dimension T extending between the two opposing sides 26.

The sides 26, 28 of the splice tray 12 are located along a majority of the perimeter of the planar surface 24 and at least partially define an interior 30 of the splice tray 12. An open side 34 is located at the first end 20 of the base 16 to provide side access to the interior 30. The open side 34 functions as a cable entry and a cable exit of the splice tray arrangement 10.

Referring back to FIG. 1, at least one of the tray sides includes cover attachment structure 32. In the illustrated embodiment, the cover attachment structure 32 includes openings 32 formed in one of the opposing sides 26 of the spice tray 12. In an alternative embodiment, the cover attachment structure 32 can be formed in the transverse side 28 located at the second end 22 of the splice tray 12. The openings 32 in the illustrated embodiment are constructed to receive mating structure (not shown), such as a rib, located on an inner surface of an edge 36 of the cover 14. The mating structure typically snap-fits within the openings 32 of the base 16 to at least partially enclose the interior 30 of the splice tray 12.

Referring to FIGS. 1 and 2, the arrangement 90 for storing slack cable of the splice tray arrangement 10 includes first and second radius limiters 40, 42 positioned on the planar surface 24 of the splice tray 12. The first radius limiter 40 is located adjacent to the first end 20 of the base 16 and the second radius limiter 42 is located adjacent to the second end 22 of the base. Each of the first and second radius limiters 40, 42 is integrally formed with the base 16 of the splice tray 12. In particular, the radius limiters 40, 42 each include a wall 46 (FIG. 1) that projects outward from the planar surface 24 of the splice tray 12. The projecting wall 46 is a molded construction formed on the planar surface 24; accordingly, the radius limiters 40, 42 are made of a similar material to that of the base 16, as previously described.

The radius limiters 40, 42 are constructed to limit the bend radius of cables 100 when the cables are wrapped about the limiters for storage and/or organizational purposes. In particular, each of the radius limiters 40, 42 has an outer diameter OD (FIG. 2) defined by the projecting wall 46 of radius limiter. The outer diameter OD is preferably no less than 3.0 inches to provide a minimum bend radius of 1.5 inches; although the disclosed principles can be applied in a variety of sizes and applications depending upon the type of cable, for example. In the illustrated embodiment, the outer diameters OD of the radius limiters 40, 42 are the same. In other embodiments, the outer diameter of the radius limiters may be different.

Each of the radius limiters 40, 42 further includes tabs 44. The tabs extend radially outward from the walls 46 the radius limiters 40, 42. Referring to FIG. 1, the tabs are located adjacent to a top edge 48 of the wall 46 of each radius limiter so that a gap G (FIG. 1) is provided between the tab 44 and the planar surface 24 of the base. Cables are tucked under the tabs 44 and within the gap G during storage. The tabs 44 retain the cables about the radius limiters. Side tabs 76 are also formed along each of the sides 26, 28 of the splice tray 12 for retaining cables within the interior 30 of the tray. In the illustrated embodiment, slots 94 are formed in the planar surface 24 opposite each of the tabs 44, 76 for manufacturing purposes.

Referring to FIG. 1, the arrangement 80 for holding splice components includes a plurality of slots or channels 52 within which the splice components 110 are placed and held. As shown in FIG. 2, each of the channels 52 runs parallel to one another. In the illustrated embodiment, the arrangement 80 for holding splice components includes twelve parallel channels 52.

The channels 52 of the arrangement 80 for holding splice components are partially defined by retaining structure 50 of the holding element 18. As previously described, the holding element 18, and accordingly, the retaining structure 50 are integrally molded to the planar surface 24 of the splice tray 12. The channels 52 are also defined by curved fingers 60 projecting from the base 16 of the splice tray. The curved fingers 60 are integrally formed on the planar surface 24 of the splice tray 12, similar to the projecting walls 46 of the radius limiters 40, 42. Therefore, the fingers 60 are made of a similar material to that of the base 16 of the splice tray, as previously described.

The holding element 18 and the fingers 60 of the arrangement 80 are positioned between the first and second radius limiters 40, 42. In particular, the holding element 18 and the fingers 60 are positioned such that no portion of the holding element 18 or the fingers 60 extends beyond tangent lines (shown as dashed lines in FIG. 2) interconnecting diameters that circumscribe the radius limiters 40, 42. In the illustrated embodiment, the first and second radius limiters 40, 42 are aligned with each other along a shared centerline (cl). The holding element 18 and the fingers 60 of the arrangement 80 are also generally centered on or aligned with the shared centerline (cl).

As shown in FIG. 2, the channels 52 are oriented in a non-perpendicular angle A relative to the longitudinal dimension L of the base 16. In particular, the channels 52 are diagonally oriented relative to the longitudinal and transverse dimensions of the base 16. Each of the channels has a diagonal length (dl) that extends a majority of the distance between the tangent lines interconnecting the diameters that circumscribe the radius limiters 40, 42.

Still referring to FIG. 2, each of the channels 52 of the splice tray arrangement 10 includes a curved entrance region 56 and a curved exit region 58. The curved entrance and the curved exit regions 56, 58 of the channels 52 are defined by the curved fingers 60 formed on the planar surface 24 of the base 16. The fingers 60 are arranged to align with the retaining structure 50 of the holding element 18. The fingers 60 and the retaining structure 50 are aligned so that the channels 52 of the splice tray arrangement 10 are continuous from the entrance region 56 to the exit region 58 when the holding element 18 is over-molded to the base 16.

Referring back to FIG. 1, the retaining structure 50 of the arrangement 80 for holding splice components preferably includes two types of retaining structure: a first type 66 configured to retain stranded heat shrink splice components 112; and a second type 68 configured to retain mass fusion splice components 114.

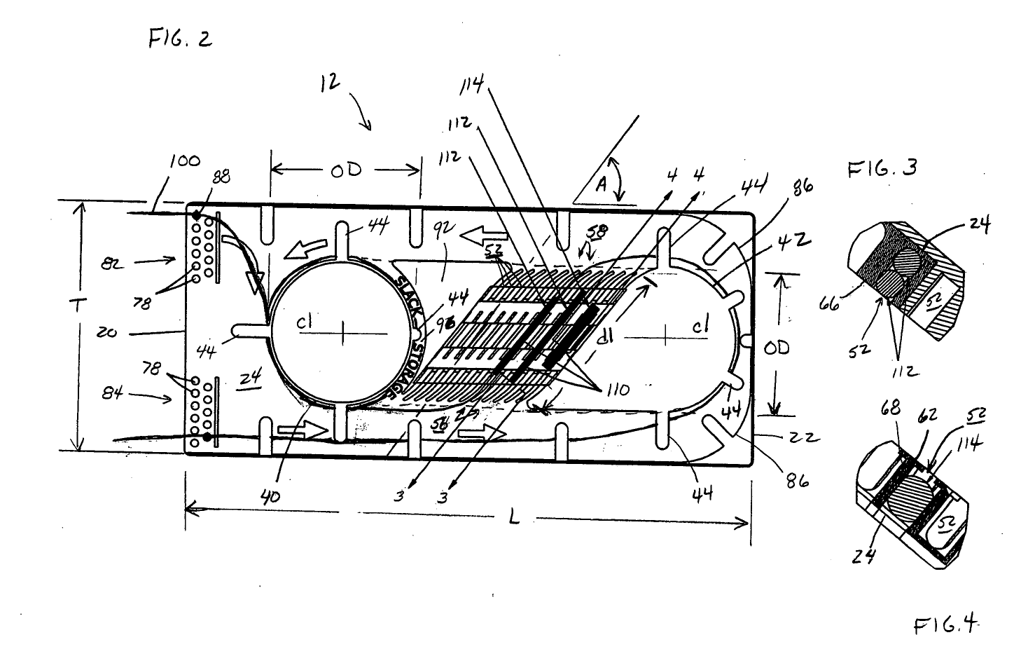

The first type 66 of retaining structure includes first and second outer rows of retaining structure 66. As shown in FIG. 3, the first and second outer rows of retaining structure 66 have a configuration sized to receive heat shrink splice components 112 having diameter of between about 0.070 inches and 0.150 inches; typically between about 0.105 inches and 0.115 inches. In the illustrated embodiment, two heat shrink splice components 112 are positioned within one channel 52. Accordingly, the illustrated holding element 18 having twelve channels 52 can hold twenty-four heat shrink splice components 112. In the alternative, only one heat shrink splice component may be placed within the channel 52.

The number of heat shrink splice component 112 positioned within one channel 52 is generally determined by the height of the outer rows of retaining structure 66. The height of the outer rows of retaining structure is in turn typically determined by the profile height of the splice tray 12. As can be understood, the disclosed principles can accordingly be applied in a variety of sizes and applications.

As can be seen in FIG. 3, the outer rows of retaining structure 66 provide a slight interference fit to secure the one or two heat shrink splice components 112 within the channel 52. To accommodate placement of the splice components while still providing a securing interference fit, the construction of the outer rows of retaining structure 66 is preferably a flexible construction. Types of material that can be used to provide the preferred flexible construction include common engineering polymers such as flexible polyolefin based materials, for example. In the alternative, the outer rows of retaining structure 66 may include a cross-sectional shape that by its configuration provides the needed flexibility.

The second type 68 of retaining structure includes an intermediate row of retaining structure. As shown in FIG. 4, the intermediate row of retaining structure 68 has a configuration sized to receive mass fusion components 114 having a diameter of between about 0.130 inches and 0.230 inches; typically between about 0.150 inches and 0.170 inches. In the illustrated embodiment, one mass fusion component 114 is positioned within one of the channels 52; although the disclosed principles can be applied in a variety of sizes and applications.

As can be seen in FIG. 4, the intermediate row of retaining structure 68 provides a slight interference fit to secure the mass fusion splice component 114 within the channel 52. Accordingly, to accommodate placement of the splice components while still provide a securing interference fit, the construction of the intermediate row of retaining structure 68 also preferably includes a flexible construction, similar to the outer rows of retaining structure 66. In the illustrated embodiment, both the outer rows of retaining structure 66 and the intermediate row of retaining structure 68 are an integral part of the holding element 18 and are constructed of the same type of material, as discussed above; although it is contemplated that each of the types of retaining structure 66, 68 can be constructed of different materials.

Still referring to FIG. 4, the intermediate row of retaining structure includes flanges 62 that define a generally T-shaped cross-section. Each flange 62 assists in retaining or capturing the mass fusion splice component 114 within the portion of the channel 52 defined by the intermediate row of retaining structure 68. The flanges 62 also functions to assist in retaining the one or two heat shrink splice components 112 placed within the channel 52 but held by the outer rows of retaining structure 66.

In use, the splice tray arrangement 10 houses spliced fiber optic cables 100 (FIG. 2). The fiber optic cables 100 enter and exit through the open side 34 of the splice tray 12. To manage the organization of cables entering and exiting the splice tray 12, the cables can be fixed at a particular entering and exiting location on the base 16. For example, apertures 78 are provided adjacent to the open side 34 of the splice tray 12. A tie 88 or other secure device placed through the aperture(s) 78 can be used to tie or secure the cable 100 at the particular entering and exiting location.

Referring now to FIG. 2, when organizing or filling the splice tray arrangement 10, fiber optic cables entering adjacent to a first set 82 of apertures 78 are routed around the first radius limiter 40, as shown by arrows. Fiber optic cables entering adjacent to a second set 84 of apertures 78 simply run straight forward toward the second end 22 of the splice tray 12, as shown by arrows. In the illustrated splice tray arrangement 10, the arrows are formed in the planar surface 24 of the base 16 during the molding process. The arrows assist the user in properly arranging the cables within the splice tray 12. (For purposes of clarity, only one cable 100 is shown and is associated with one of the stranded heat shrink splice components 112.)

Depending upon the amount of slack, the cables can either be directly fed into one of the channels 52 of the arrangement 80 for holding splice components or routed about the arrangement 90 for storing cable slack. When storing slack cable, the cable 100 is routed from the open side 34 of the splice tray 12 and can be wrapped about only the first radius limiter 40, or wrapped about both of the first and the second radius limiters 40, 42 as needed. The arrangement of the cable radius limiters 40, 42 and the diagonal orientation of the holding element 18 and fingers 60 make the splice tray arrangement 10 easy to use when organizing and storing fiber optic cables 100. That is, even aside from the arrows formed on the base 16 of the splice tray 12, the overall splice tray arrangement provides or creates a cable pathway that is inherent to the tray's design. The inherent cable pathway simplifies cable management and reduces the possibility of cable damage due to improper cable routing.

When the necessary amount slack is properly stored about the radius limiter(s) 40, 42, the fiber optic cable 100 is then routed to the arrangement 90 for holding splice components. In particular, the cable 100 is routed into the curved entrance region 56 of the arrangement 90 and positioned within the channels 52 such that the splice component 110 of the cable 100 is retained by the retaining structure 50 of the holding element 18. The cable then exits through the curved exit region 58 and is wrapped around the second radius limiter 42 in a clockwise direction. The cable 100 exits the splice tray arrangement 10 at the open side 34 at which the cable entered. In the illustrated embodiment, the cable 100 is shown to enter the splice tray 12 adjacent to the first set 82 of apertures and exit the splice tray 12 adjacent to the second set 84 of apertures; the cable may enter or exit in the alternative, or may both exit and enter adjacent to the same set of apertures.

While the present disclose refers to channel “exit and entry” regions (i.e., 56, 58), it will be appreciated that these regions need not be limited to strictly “an exit” region or strictly “an entry” region. Rather, the exit and entry regions are used for explanatory purposes of the illustrated embodiment. Routing cables in a reverse manner is within the scope of the present disclosure. For example, a cable can enter the open side 34 of the tray 12, wrap about the second radius limiter 42, enter the exit region 58 of the channels 52, and then exit the channels 52 at the entry region 56.

As previously discussed, care must be taken to avoid excessive bending in applications involving fiber optic cables. For single fiber cables and for ribbon cables, it is desirable to avoid exceeding a minimum bend radius of 1.5 inches.

With the disclosed splice tray arrangement 10, no cable stored or held within the splice tray 12 will exceed the minimum bend radius of 1.5 inches. For example, the splice tray 12 is arranged so that a cable 100 tied even at a far outer aperture 78, as shown in FIG. 2, does not exceed the minimum bend radius of 1.5 inches when routed to wrap around the first radius limiter 40. Similarly, the curved entrance and exit regions 56, 58 of the channels 52 are configured so that the cable 100 does not exceed the minimum bend radius of 1.5 inches. In addition, the present cable tray arrangement 10 includes corner fillets 86 integrally molded as part of the base 16. The corner fillets 86 are provided to prevent cables from pushing into the corners of the splice tray 12 and bending beyond the minimum bend radius of 1.5 inches.

In addition to providing minimum bend radius protection, the splice tray arrangement 10 of the present disclosure is also easy to use. The ease of use ensures proper installation or placement of fiber optic cables so that the desired bending radius protection is achieved. The ease of use is accomplished, for instance, by the arrows formed in the tray and the diagonal orientation of the channels 52 that assist the user in properly routing cables within the splice tray arrangement 10.

In addition, the splice tray 12 includes an island 92 (FIG. 2) integrally formed on the base 16. The island 92 creates a cable pathway or channel 96 around the first radius limiter 40 and contributes to the inherent flow and easy-to-follow cable pathways of the splice tray arrangement 10. Also, the second radius limiter 42 includes an extended portion 98 (FIG. 1). The extended portion 98 and the island 92 essentially fill the central region of the splice tray 12 so that the cables cannot be improperly routed and inadvertently bent to exceed the desired minimum bend radius. The extended portion 98 also contributes to the inherent flow and easy-to-follow cable pathways of the present arrangement 10.

The overall arrangement and construction of the disclosed splice tray arrangement 10 enhances cable management by providing an easy to use design that also maintains a minimum bend radius of cables to prevent cable attenuation. The above specification provides a complete description of the invention. Since many embodiments of the invention can be made without departing from the spirit and scope of the invention, certain aspects of the invention reside in the claims hereinafter appended.

1. A splice tray arrangement, comprising:
a) a base having a generally longitudinal dimension and a transverse dimension;
b) a first radius limiter and a second radius limiter, each of the first and second radius limiters being integrally formed on the base; and
c) a splice holding element integrally molded on the base, the holding element including retaining structure that defines a plurality of channels, each of the channels being configured to receive either one of both of a stranded heat shrink splice component and a mass fusion splice component, each of the channels being oriented at a non-perpendicular angle relative to the longitudinal and transverse dimensions.

2. (canceled)

3. The arrangement of claim 1, wherein the channels include a curved entry and a curved exit.

4. The arrangement of claim 3, wherein the curved entry and the curved exit are defined by curved fingers.

5. The arrangement of claim 4, wherein the curved fingers are integrally formed on the base.

6. The arrangement of claim 3, wherein the curved entry and the curved exit of the channels have a predefined bend radius, the predefined bend radius being no less than 1.5 inches.

7. The arrangement of claim 1, further including fingers integrally formed on the base, the fingers being located adjacent to the retaining structure to define curved channel entrances and curved channel exits.

8. The arrangement of claim 7, wherein the first and second radius limiters, the retaining structure, and the fingers are each constructed and arranged relative to one another such that no portion of a cable placed within the splice tray arrangement exceeds a minimum bend radius of 1.5 inches.

9. The arrangement of claim 7, wherein the base has a first end and a second end, the first radius limiter being positioned adjacent to the first end of the base, the second radius limiter being positioned adjacent to the second end of the base, and wherein the splice holding element is located between the first and second radius limiters.

10. A splice tray arrangement, comprising:
a) a base having a first end and a second end;
b) a first radius limiter positioned adjacent to the first end of the base, and a second radius limiter positioned adjacent to the second end of the base; and
c) splice holding channels located on the base between the first and second radius limiters, the channels having a curved entrance region and a curved exit region, each of the splice holding channels being configured to hold either one of both of a stranded heat shrink splice component and a mass fusion splice component.

11. The arrangement of claim 10, wherein the base has a longitudinal dimension and a transverse dimension, and wherein each of the splice holding channels is diagonally oriented relative to the longitudinal and transverse dimensions.

12. The arrangement of claim 1 wherein the curve entrance region and the curved exit region are defined by curved fingers.

13. The arrangement of claim 12, wherein the first and second radius limiters, the splice holding channels, and the fingers are each constructed and arranged relative to one another such that no portion of a cable placed within the splice tray arrangement exceeds a minimum bend radius of 1.5 inches.

14. The arrangement of claim 10, wherein the first and second radius limiters and the splice holding channels are integrally formed with the base to define a one-piece unit.

15. The arrangement of claim 14, further including a cover that attaches to the one-piece unit to at least partially enclose the splice tray arrangement.

16. (canceled)

17. The arrangement of claim 10, wherein each of the splice holding channels is configured to hold multiple stranded heat shrink splice components.

18. The arrangement of claim 10, wherein the channels are defined by rows of flexible retaining structure, the rows including an intermediate row of flexible retaining structure having a T-shaped cross-section configured to capture mass fusion splice components placed within the channels.

19. The arrangement of claim 18, wherein the rows further include outer rows of flexible retaining structure arranged to capture the ends of stranded heat shrink splice components placed within the channels.

20. The arrangement of claim 1, wherein each of the channels of the splice holding element is configured to hold multiple stranded heat shrink splice components.

21. The arrangement of claim 1, wherein the retaining structure includes rows of flexible retaining structure, the rows including an intermediate row of flexible retaining structure having a T-shaped cross-section configured to capture mass fusion splice components placed within the channels.

22. The arrangement of claim 21, wherein the rows further include outer rows of flexible retaining structure arranged to capture the ends of stranded heat shrink splice components placed within the channels.

23. A splice tray arrangement, comprising:
a) a base having a generally longitudinal dimension and a transverse dimension;
b) a first radius limiter and a second radius limiter, each of the first and second radius limiters being integrally formed on the base; and
c) a splice channels located on the base between the first and second radius limiters, each of the channels being configured to receive either one of both of a single mass fusion splice component, and multiple stranded heat shrink splice components.
